(19) United States
(12) Patent Application Publication
(10) Pub. No.: US 2008/0177790 A1
(43) Pub. Date: Jul. 24, 2008

(54) Distributed records management system

(76) Inventor: Mangesh Krishnarao Honwad, Chadds Ford, PA (US)

Correspondence Address: Gregory P. Gadson, Esq., 19375 Amber Way, Noblesville, IN, 46060, US

(21) Appl. No.: 11/655,531

(22) Filed: Jan. 19, 2007

(51) Int. Cl. G06F 7/06

(52) U.S. Cl. 707/104.1; 707/E17.002

(57) ABSTRACT

A novel records management system for managing the records of an organization at least includes: a central records policy manager which provide access to organization documents; a plurality of local records policy managers which provide access to organization documents; a network adapted to couple the local records policy managers, and adapted to couple the local records policy managers to the central records policy manager; and a system synchronizer adapted to synchronize local records document management changes performed by the local records document managers with the central records policy manager. The central records policy manager at least includes: a central document life cycle manager; a central records life manager; and a central document management rule module adapted to implement and modify an organization document management rule set. The local records policy managers at least include: a local document life cycle manager; a local records life manager; and a local document management rule module adapted to implement and manage the organization document management rule set. The local records policy managers are adapted to carry out document management functions independent of the central records policy manager.

### CROSS-REFERENCE TO RELATED APPLICATIONS

This invention claims priority under 35 U.S.C. §120 to the U.S. Provisional Patent Application No. 60/759,890 to Mangesh Krishnarao Honwad, filed on Jan. 18, 2006, for “Distributed Records Management System,” which is hereby incorporated by reference.

### BACKGROUND OF THE INVENTION

1. Field of the Invention

The present invention generally relates to document and record management systems and methods, and particularly relates to improvements in document and record management systems and methods under the control of an organization.

2. Background

Document management systems are familiar to most present-day computer users, although the inner workings of such systems may not be known or understood by most. Broadly, document management systems attempt to allow for one or more of the following on a shared basis to a number of users: document creation, document modification, document retention and document destruction. There is also a need to control access to documents, and even with access, to control the type of permission given to an accessing user with respect to the ability to affect the underlying document.

An organization with a large number of users with potential document access must also regulate now and to whom access will be granted to common documents, how and to whom common documents will be created, and how and to whom common documents may be modified, stored or purged.

In such environments, the term “document life cycle management” refers to the creation and progression of a document including review, amendment, etc. Also in such environments, the term “records life cycle management” refers to the movement, disposition, and other treatment of a document from its creation until it is deleted or destroyed. In the records life cycle management process, control of the document with respect to the following phases occurs: whether the document is a Work in Progress is (“WIP”), whether it is active, whether it is expiring, and after a specified review period is reached, whether the document is expired, or destroyed/disposed. In the records life cycle management process each document is assigned special tags which identify salient information related to the document, such as organization department affiliation, subject matter, and those who have modified or accessed the document.

A hierarchical rule set defined by the organization determines who the document (considering its tags) is to be treated during the records life cycle process.

The typical prior art approach to document and records management uses a centralized document and records manager through which all common documents are created and managed. Authorized users can gain access to the common documents through local or remote networks (such as the World Wide Web). This leaves critical document and record management functions in the control of a few having access to the central module to avoid unauthorized access. This approach, while generally having good security features, can lead to system bottlenecks as all document and record management must involve the central function, leading to unacceptably high latency times in some cases, and other problems stemming from resource limitations.

What is sorely needed but not provided for by the prior art, is a more sophisticated document and record management solution for organizations which does not require all document management and document record management functions to be centrally performed, while at the same time providing for a cohesive system where document and record management is intelligently monitored.

### SUMMARY OF THE INVENTION

In view of the aforementioned problems and deficiencies of the prior art, the present invention provides a novel records management system for managing the records of an organization that least includes: a central records policy manager which provide access to organization documents; a plurality of local records policy managers which provide access to organization documents; a network adapted to couple the local records policy managers, and adapted to couple the local records policy managers to the central records policy manager; and a system synchronizer adapted to synchronize local records document management changes performed by the local records document managers with the central records policy manager. The central records policy manager at least includes: a central document life cycle manager; a central records life manager; and a central document management rule module adapted to implement and modify an organization document management rule set. The local records policy managers at least include: a local document life cycle manager; a local records life manager; and a local document management rule module adapted to implement and manage the organization document management rule set. The local records policy managers are adapted to carry out document management functions independent of the central records policy manager.

The present invention also provides a records management method for managing the records of an organization that at least includes: via a central records policy manager, providing access to organization documents; via a plurality of local records policy managers, providing access to organization documents; networking the local records policy managers; coupling the local records policy managers to the central records policy manager; wherein the local records policy managers are adapted to carry out document management functions independent of the central records policy manager; and via a system synchronizer, synchronizing local records document management changes performed by the local records document managers with the central records policy manager. Via the central records policy manager, the method further at least includes: via a central document life cycle manager, managing the document life of organization documents; via a central records life manage, managing the records life of the organization documents; and via a central document management rule module, implementing and modifying an organization document management rule set. Via the local records policy managers, the method further at least includes: via a local document life cycle manager, managing the document life of organization documents; via a local records life manage, managing the records life of the organization documents; and via a local document management rule module, implementing and modifying an organization document management rule set.

### BRIEF DESCRIPTION OF THE DRAWING FIGURES

Features and advantages of the present invention will become apparent to those skilled in the art from the description below, with reference to the following drawing figures, in which:

FIG. 1 is a schematic diagram of a first embodiment of the present-inventive distributed records management system;

FIG. 2 is schematic diagram of a second embodiment of the present-inventive distributed records management system;

FIG. 3 is a schematic diagram of the basic components of the centralized records policy manager and of the localized policy managers of the present-inventive distributed records management system; and

FIG. 4 is a flowchart detailing the present-inventive distributive records management method.

### DESCRIPTION OF THE PREFERRED EMBODIMENTS

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network

As used in the following description, “document” is a broad term subsuming not only textual and graphical documents and files, but documents and files with audio, video and other multimedia content as well. In fact, “document” encompasses not only electronically created files, but “hard-copy” and physical documents and records as well.

In summary, the present invention distributes the document management and records management functions to a number of networked localized computers containing local records policy managers. The network involved need not be a local area network (LAN) but may be a wide area network (WAN) such as the Internet. The local records policy managers duplicate the basic functions of a centralized records policy manager. In this manner, an authorized user may perform document management and records management functions using local computers without having to have document and records management functions directly regulated by a centralized policy manager. The result is a flexible system that avoids bottlenecks at the centralized records policy manager and allows localized workstations to conduct document and records management functions in a peer-to-peer manner when documents of interest reside on, or are directly accessed by a networked local workstation.

The centralized records policy manager contains a master record of document and records management within the system, and is therefore synchronized periodically with the document and records management actions taken by the localized records policy managers.

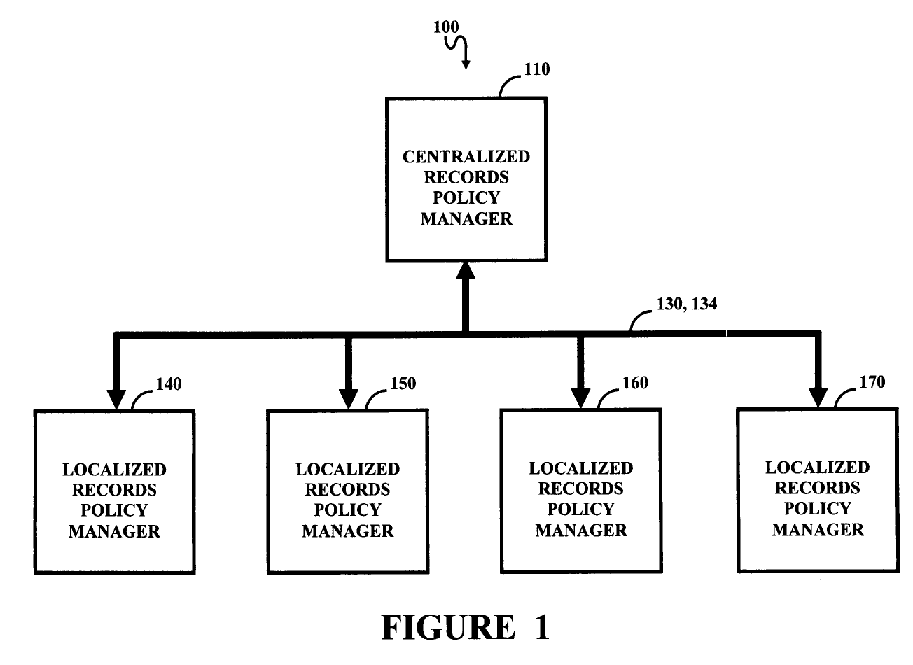

A schematic diagram of the present-inventive system 100 for distributed records management is shown in FIG. 1. A centralized records policy manager 110 is the primary regulator of document and records management in the system 100. Several localized records policy managers 140, 150, 160 and 170 shown for illustrative purposes are part of workstations which remote system users can utilize for conventional computing functions, as well as document and records management functions.

Redundancies in the localized records policy managers 140, 150, 160 and 170 allow the workstations to bypass the centralized records policy manager 110 to perform local document and records management functions, as well as to communicate peer-to-peer with other local workstations where efficacious.

Each local workstation with a local records policy manager is also capable of performing records review and records disposition functions on documents according to stored system rules, while operating in a stand-alone mode.

Also, each of the workstations can be dedicated to the document and records management functions of particular organization departments, subject matter, and the like. For example, one local records policy manager may be specially suited for a manufacturing group, while another may be specially suited for a product development group, yet another may be specially suited for a quality assurance group, and still another may be specially suited for a legal or regulatory group. Those skilled in the art will appreciate that many other variations are possible.

The numbers 130 and 134 symbolically represent first and second networks providing connectivity between the system components, with the first network acting to connect workstations to each other, and the second network acting to connect workstations to the central records policy manager. In practice, the two networks may be the same, and one, both or the combination may be carried out via the Internet.

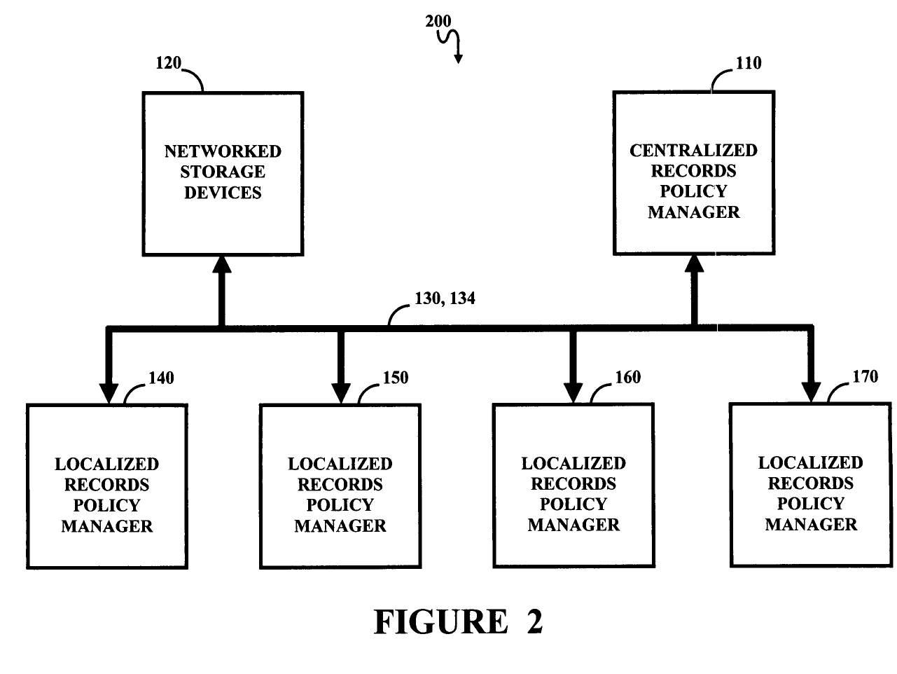

In a slightly different embodiment shown in FIG. 2, the system (represented by the number 200 to distinguish it from the system of FIG. 1) contains all of the components of FIG. 1, and additionally includes a number of networked storage devices represented by the number 120. Such devices 120 may form the physical components which may be a part of a relational database, as will be appreciate by those skilled in the art to which the present invention pertains.

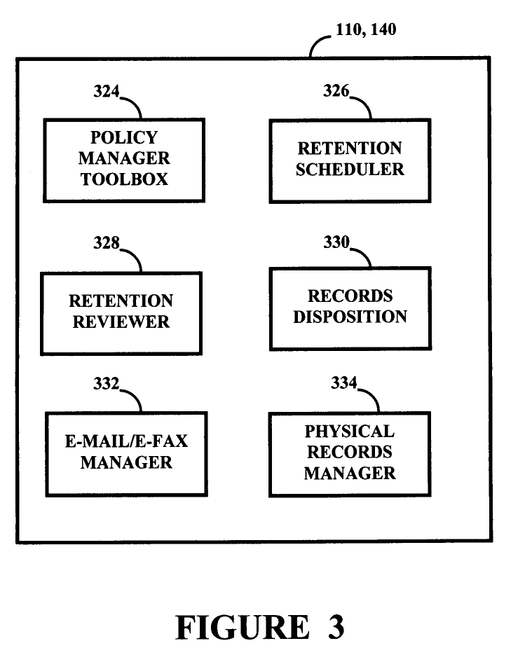

Turning to FIG. 3, the centralized records policy manager 110 nominally includes the components shown. A policy manager toolbox 324 may be accessed by authorized users using a graphical user interface (GUI). The toolbox 324 contains information such as the system retention schedule, organization structures, control tables, and physical location and container identifiers for physical documents. The toolbox 324 further contains tools that define record categories, relative and absolute retention periods, define review periods and set and remove record review and destruction cycle moratoriums.

A retention scheduler 326 applies retention periods to all documents based upon the type of document and other information. In one embodiment of the present invention the retention scheduler 326 automatically provides a document date and file format modified by the user.

A retention reviewer 328 applies the appropriate destruction dates to the records according to data and a retention code. The retention codes may indicate a time period, after which destruction of the document is to occur. Similarly, the retention code may indicate that destruction of the document may depend upon a contingent event, the occurrence of which triggers the scheduled destruction. Alternatively, the retention code can be a hybrid of the “time” and “event” categories described above which combines a certain length of time after a contingent event before destruction is scheduled. This may be designated as an “event plus time” retention code. The retention rules can also be set to allow authorized users to review records scheduled for destruction, and place holds delaying the destruction, if desired.

A records disposition module 330 automatically deletes records when destruction is scheduled and no holds have been placed on the particular records. The destruction of a record also includes backup copies in the normal course. A record of all disposition action is stored.

The records policy managers of the present invention also include an e-mail/e-fax manager 332 which allows e-mail messages and facsimile communications to conveniently be saved to storage as records.

A physical records manager 334 manages physical records that are not or cannot be electronically stored by providing unique location identifiers and other indicia to help track such documents.

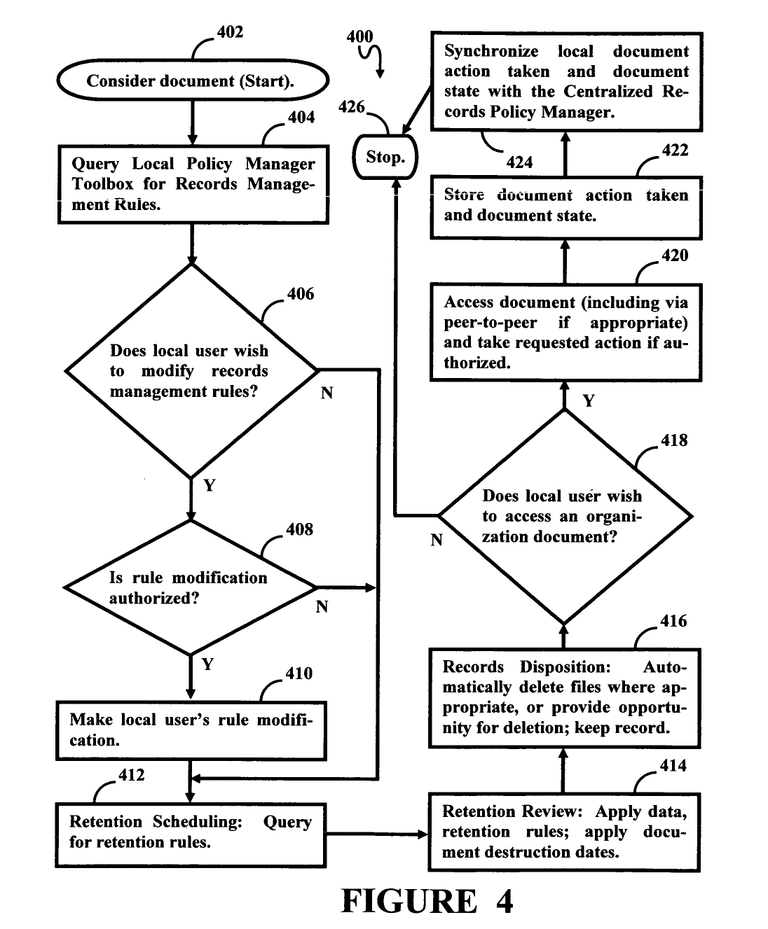

A general flowchart numbered 400 is shown in FIG. 4, which covers processes which may be carried out by a local records policy manager. It should be understood that the workstations can be conventional computers which have had special software installed according to the present invention. Further, a variety of electronic data devices may also be compatible with the teachings of the present invention when such devices are appropriately modified.

The algorithm 400 begins with Step 402 when a local user considers accessing a particular document. In Step 404 the local policy manager toolbox is queried for the applicable records management rules. During a session a user may desire to modify one or more records management rules. In such a case, the algorithm determines whether the rule modification is authorized (Steps 406 and 408). If authorized, the rule modifications are implemented (Step 410). If not authorized, the proposed rule modifications are not implemented and the algorithm advances to Step 412, where the retention scheduler is queried for the applicable retention rules.

The retention rules are reviewed in Step 414, where the data and retention rules are applied, as well as document destruction dates. In Step 416 (“Records Disposition), documents are automatically deleted where appropriate, and records of the deletions are kept.

If the local user desires to access an organization document, such document is accessed, provided the user has authority (Steps 418 and 420). If not, the algorithm jumps to Step 426 and stops. Document access and records management can include peer-to-peer communication. After Step 420 the action taken with regard to the document is stored (Step 422).

At the end of the local records management process, the central records policy manager is synchronized to include all changes (Step 424), so that the central records policy manager contains a master record. Synchronization can occur at a variety of intervals, including each time a local records policy manager is in communication with the central records policy manager, at specified scheduled time intervals, or at other times.

Variations and modifications of the present invention are possible, given the above description. However, all variations and modifications which are obvious to those skilled in the art to which the present invention pertains are considered to be within the scope of the protection granted by this Letters Patent.

What is claimed is:

1. A records management system for managing the records of an organization comprising:
a central records policy manager which provide access to organization documents;
a plurality of local records policy managers which provide access to organization documents;
a network adapted to couple said local records policy managers, and adapted to couple said local records policy managers to said central records policy manager;
wherein said central records policy manager comprises:
a central document life cycle manager;
a central records life manager; and
a central document management rule module adapted to implement and modify an organization document management rule set;
wherein said local records policy managers comprise:
a local document life cycle manager;
a local records life manager; and
a local document management rule module adapted to implement and manage said organization document management rule set;
wherein said local records policy managers are adapted to carry out document management functions independent of said central records policy manager; and
a system synchronizer adapted to synchronize local records document management changes performed by said local records document managers with said central records policy manager.

2. The system of claim 1, wherein said local records policy mangers are adapted to provide document management directly without involvement of the central records policy manager.

3. The system of claim 1, wherein said first network is adapted to provide peer-to-peer records management between said local records policy managers.

4. A records management method for managing the records of an organization comprising:
via a central records policy manager, providing access to organization documents;
via a plurality of local records policy managers, providing access to organization documents;
networking said local records policy managers;
coupling said local records policy managers to said central records policy manager;
wherein via said central records policy manager, said method further comprises:
via a central document life cycle manager, managing the document life of organization documents;
via a central records life manage, managing the records life of said organization documents; and
via a central document management rule module, implementing and modifying an organization document management rule set;
wherein via said local records policy managers, said method further comprises:
via a local document life cycle manager, managing the document life of organization documents;
via a local records life manage, managing the records life of said organization documents; and
via a local document management rule module, implementing and modifying an organization document management rule set;
wherein said local records policy managers are adapted to carry out document management functions independent of said central records policy manager; and
via a system synchronizer, synchronizing local records document management changes performed by said local records document managers with said central records policy manager.

5. The method of claim 4, further comprising:
via said local records policy mangers, providing document management directly without involvement of the central records policy manager.

6. The method of claim 4, further comprising, via said first network, providing peer-to-peer records management between said local records policy managers.
